(19) United States
(12) Patent Application Publication
(10) Pub. No.: US 2019/0147071 A1
(43) Pub. Date: May 16, 2019

(54) METHODS AND SYSTEMS FOR ALGORITHMICALLY COMPARING GEOGRAPHICAL AREAS USING ARTIFICIAL INTELLIGENCE TECHNIQUES

(71) Applicants: Will Shapiro, New York, NY (US); Mahir Yavuz, Brooklyn, NY (US)

(72) Inventors: Will Shapiro, New York, NY (US); Mahir Yavuz, Brooklyn, NY (US)

(21) Appl. No.: 16/190,083

(22) Filed: Nov. 13, 2018

Related U.S. Application Data
(60) Provisional application No. 62/585,309, filed on Nov. 13, 2017.

(51) Int. Cl. G06F 17/30; G06K 9/62; G06F 17/18; G06F 17/27

(52) U.S. Cl. CPC G06F 17/30241; G06F 17/27; G06F 17/18; G06K 9/6215

(57) ABSTRACT

According to some aspects, a system is provided comprising a processor, a storage device coupled to the processor, a memory device coupled to the processor and memory, an interface adapted to receive a plurality of parameter values relating to a plurality of geographical areas, a plurality of components, executable by one or more processors, the components comprising a component adapted to determine, for each of the plurality of geographical areas, a respective profile, the profile including a plurality of data points relating to activity performed within a respective area, a component adapted to determine a respective normalized profile based on each respective profile associated with the plurality of geographical areas, and a component adapted to determine a similarity measure of at least one of the plurality of geographical areas to a reference geographical area.

### CROSS REFERENCE TO RELATED APPLICATIONS

This application claims the benefit of U.S. Provisional Application No. 62/585,309 filed Nov. 13, 2017, the entirety of which is incorporated by reference herein.

### BACKGROUND

People looking to move to a new city or neighborhood may look to numerous online sources to obtain relevant information. For example, such sources may provide information, such as demographic information or average property values, for the new city or neighborhood of interest. The person looking to move may put together the provided information while considering their decision regarding the move to a new city or neighborhood. The person may or may not find this information useful in making their decision.

### SUMMARY

In some embodiments, a system is provided for algorithmically determining the level of similarity between different geographical areas such as, for instance, neighborhoods and cities, using one or more artificial intelligence techniques. It is appreciated that understanding the degree to which different neighborhoods and cities are similar or different can be used for several different purposes including but not limited to recommending neighborhoods for people looking to move or travel to new cities and neighborhoods, guiding commercial and residential real estate development and investment, informing scaling strategy for companies and restaurant groups that require brick and mortar locations and empowering recommendation for location based services and technologies including mobile phone applications, augmented reality applications and autonomous vehicles. In some embodiments, a computer-implemented system is provided that receives information relating to a number of geographic location areas and determines similarities between location areas. Such similarity information may be outputted to one or more entities such as a recommendation engine, an advertising server, or other systems capable of performing actions responsive to the similarity information. According to one aspect, a similarity model may be used which operates more efficiently and quickly to enable applications and users to receive real-time similarity information.

According to some aspects, a system is provided comprising a processor, a storage device coupled to the processor, a memory device coupled to the processor and memory, an interface adapted to receive a plurality of parameter values relating to a plurality of geographical areas, a plurality of components, executable by one or more processors, the components comprising a component adapted to determine, for each of the plurality of geographical areas, a respective profile, the profile including a plurality of data points relating to activity performed within a respective area, a component adapted to determine a respective normalized profile based on each respective profile associated with the plurality of geographical areas, and a component adapted to determine a similarity measure of at least one of the plurality of geographical areas to a reference geographical area.

According to some embodiments, the system further comprises a component adapted to reduce a dimensionality of each of the normalized profiles. According to some embodiments, the plurality of geographical areas include at least one of a group comprising a neighborhood, a city, a state, a user-defined area, and a virtual area.

According to some embodiments, the system further comprises a component that provides an output, the output including the determined similarity measure. According to some embodiments, the system further comprises a component adapted to determine a co-occurrence based distance metric for each of the plurality of geographical areas. According to some embodiments, the system further comprises a component adapted to determine a profile-based distance metric for each of the plurality of geographical areas. According to some embodiments, the system further comprises a component adapted to combine the co-occurrence based distance metric and the profile-based distance metric for each of the plurality of geographical areas into a single distance metric.

According to some embodiments, the system further comprises a weighting component that adjusts a weighting between the co-occurrence based distance metric and the profile-based distance metric for each of the plurality of geographical areas. According to some embodiments, the plurality of data points relating to activity performed within a respective area includes at least one of a group of data sources including POI data, photographs, map data, and census data. According to some embodiments, the plurality of data points are derived by one or more processes including statistical transformations, computer vision, map analysis, and natural language processing.

According to some aspects, a method is provided comprising receiving a plurality of parameter values relating to a plurality of geographical areas, determining, for each of the plurality of geographical areas, a respective profile, the profile including a plurality of data points relating to activity performed within a respective area, determining a respective normalized profile based on each respective profile associated with the plurality of geographical areas, and determining a similarity measure of at least one of the plurality of geographical areas to a reference geographical area.

According to some embodiments, the method further comprises reducing a dimensionality of each of the normalized profiles. According to some embodiments, the plurality of geographical areas include at least one of a group comprising a neighborhood, a city, a state, a user-defined area, and a virtual area. According to some embodiments, the method further comprises providing an output, the output including the determined similarity measure.

According to some embodiments, the method further comprises determining a co-occurrence based distance metric for each of the plurality of geographical areas. According to some embodiments, the method further comprises determining a profile-based distance metric for each of the plurality of geographical areas. According to some embodiments, the method further comprises combining the co-occurrence based distance metric and the profile-based distance metric for each of the plurality of geographical areas into a single distance metric.

According to some embodiments, the method further comprises adjusting a weighting between the co-occurrence based distance metric and the profile-based distance metric for each of the plurality of geographical areas. According to some embodiments, the plurality of data points relating to activity performed within a respective area includes at least one of a group of data sources including POI data, photographs, map data, and census data. According to some embodiments, the plurality of data points are derived by one or more processes including statistical transformations, computer vision, map analysis, and natural language processing.

According to some aspects, a system is provided comprising at least one computer hardware processor, at least one non-transitory computer-readable storage medium storing processor-executable instructions that, when executed by the at least one computer hardware processor, cause the at least one computer hardware processor to perform receiving, for each of a plurality of geographical areas, a respective plurality of parameter values, determining, for each of the plurality of geographical areas, a respective profile, the profile including a subset of the plurality of parameter values relating to activity performed within a respective geographical area, determining, for each of the plurality of geographical areas, a respective normalized profile based on the respective profile associated with the respective geographical area, and determining, for first and second geographical areas of the plurality of geographical areas, based on the respective normalized profiles for the first and second geographical areas, a similarity measure for comparing the first and second geographical areas.

According to some aspects, a method is provided comprising receiving, for each of a plurality of geographical areas, a respective plurality of parameter values, determining, for each of the plurality of geographical areas, a respective profile, the profile including a subset of the plurality of parameter values relating to activity performed within a respective geographical area, determining, for each of the plurality of geographical areas, a respective normalized profile based on the respective profile associated with the respective geographical area, and determining, for first and second geographical areas of the plurality of geographical areas, based on the respective normalized profiles for the first and second geographical areas, a similarity measure for comparing the first and second geographical areas.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

Various non-limiting embodiments of the technology will be described with reference to the following figures. It should be appreciated that the figures are not necessarily drawn to scale.

FIG. 1 is a diagram of a distributed system according to various embodiments;

FIG. 2 is a diagram of a process for determining a distance metric according to one embodiment;

FIG. 3 is a diagram of an example process for using similarity information according to various embodiments;

FIG. 4 shows an example process for determining similarity information for a plurality of locations;

FIG. 5 shows an example process for determining a ranking of candidate neighborhoods;

FIG. 6 shows an exemplary user interface for comparing two geographical areas according to one embodiment;

FIG. 7 shows another exemplary user interface for comparing two geographical areas according to one embodiment;

FIG. 8 shows an example process for determining similarities across time and neighborhood forecasting according to one embodiment;

FIGS. 9A-9B shows another example process for determining similarities across time and neighborhood forecasting according to one embodiment;

FIG. 10 shows an example implementation for learning and modeling similarity information; and

FIG. 11 shows an example computer system upon which various embodiments may be practiced.

### DETAILED DESCRIPTION

Conventional approaches have relied on intuition or local real estate expertise to compare different geographical areas, such as different neighborhoods or cities. However, such sources may not be reliable or sufficient indicators of the level of similarity between different geographical areas.

The inventors have recognized that a system for algorithmically determining the level of similarity between different geographical areas such as, for instance, neighborhoods and cities, using one or more artificial intelligence techniques may enable users and systems to better understand the degree to which different neighborhoods and cities are similar or different. For example, such a system may be used for recommending neighborhoods for people looking to move or travel to new cities and neighborhoods. In another example, such a system may be used for guiding commercial and residential real estate development and investment. In yet another example, such a system may be used for informing scaling strategy for companies and restaurant groups that require brick and mortar locations. In yet another example, such a system may be used for empowering recommendations for location based services and technologies including mobile phone applications, augmented reality applications, and autonomous vehicles.

Some embodiments of the described systems and methods improve computerized search technology by enabling automated analysis of the level of similarity between different geographical areas. Conventional approaches have relied on non-automated sources, such as intuition or local real estate expertise, to compare different geographical areas. Some embodiments of the described systems and methods replace sources, such as intuition or local real estate expertise, that could not be automated with automated analysis of the level of similarity between different geographical areas. Some embodiments of the described systems and methods produce a similarity measure of at least one of a plurality of geographical areas to a reference geographical area. The produced metrics may power predictive machine learning models for a variety of applications, e.g., for retail, commercial, and residential real estate companies, and may provide a powerful, data-driven automated approach to identifying new opportunities.

Some embodiments of the described systems and methods provide a particular solution to the problem of determining the level of similarity between different geographical areas. Some embodiments of the described systems and methods provide a particular way for automated analysis of the level of similarity between different geographical areas by receiving a plurality of parameter values relating to a plurality of geographical areas, determining, for each of the plurality of geographical areas, a respective profile, the profile including a plurality of data points relating to activity performed within a respective area, determining a respective normalized profile based on each respective profile associated with the plurality of geographical areas, and determining a similarity measure of at least one of the plurality of geographical areas to a reference geographical area.

One or more embodiments are directed to a system and process for determining similarities between geographical areas based on one or more training sets of information. Such similarity information may be used for example, to model a neighborhood and compare that neighborhood with other neighborhoods. In one implementation, given an identified geographical area (e.g., as provided by a user via a query), one or more similar neighborhoods may be retrieved and returned to the referencing program or user.

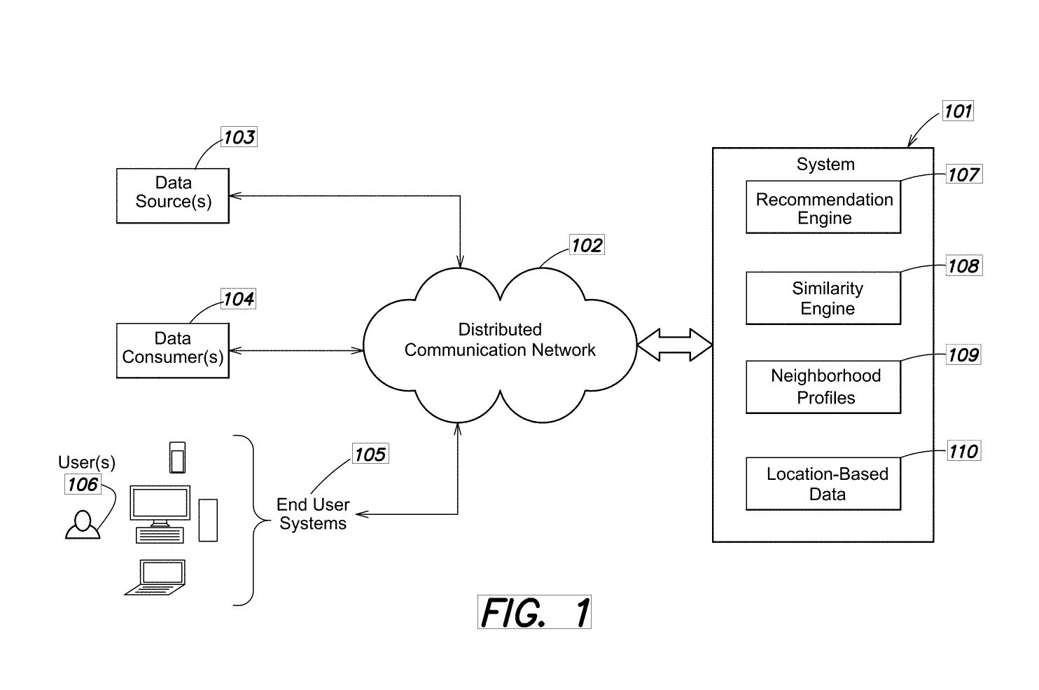

FIG. 1 shows a processing system 100 that is capable of providing similarity information for one or more systems. In particular, system 101 is coupled to one or more end user systems 105 through a distributed communication network 102. Further, system 101 may be in communication with one or more data consumers 104 that are adapted to use and/or interpret similarity information. Furthermore, system 101 may interpret one or more data sources 103 for the purposes of determining similarity at any particular point in time, training a statistical model to identify similarities, or to update the statistical model.

System 101 may include one or more elements including a recommendation engine 107, a similarity engine 108, neighborhood profiles 109, and location based data 110. In one embodiment, the similarity engine 108 is capable of determining similarity between one or more regions (e.g., neighborhoods) by performing analyses between the regions. Similarity engine 108 may evaluate one or more pieces of data provided by one or more data sources (e.g., data sources 103). The neighborhood profiles may include one or more parameters that are evaluated to determine similarity. In one embodiment, system 101 includes a recommendation engine 107 which is capable of providing a ranked list of locations that are similar to an indicated location. Further, system 101 may collect and store location based data 110 which may include, for example, information relating to various points of interest within particular geographic regions.

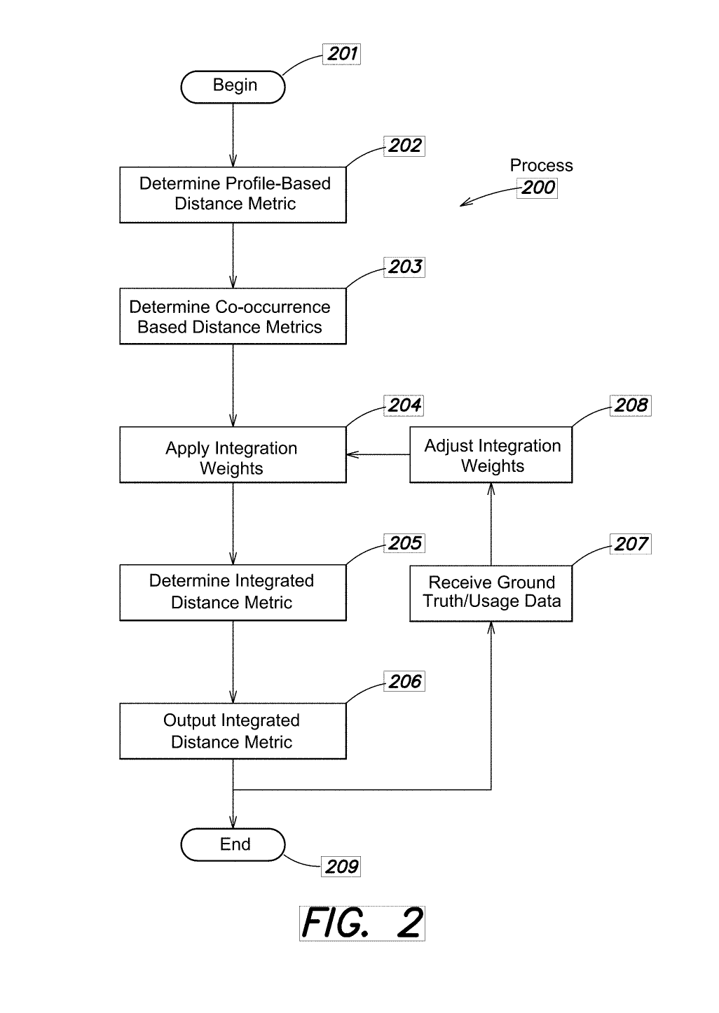

FIG. 2 shows an example process 200 for determining a distance metric. For instance, one method for indicating similarity between two or more regions includes determining one or more distance metrics. Such distance metrics may be relative to a point of interest, a particular selected region, or other parameters. At block 202, the system determines a profile based distance metric. In particular, the system may determine a neighborhood profile construction across all candidate regions as more fully discussed below. At block 203, the system may determine co-occurrence based distance metrics that identify similarity between candidate regions. At block 204, the system may apply integration weights which weight the profile-based distance metrics and the co-occurrence based distance metrics.

Combined together, the system may determine an integrated distance metric that can be used to determine the relative distance of one particular region from another region. A block 206, the system may output an integrated distance metric. Such information may be used, for example, to inform the user of similar regions, rank a particular list, or perform a particular action based on similarity measures.

Further, the system may be capable of updating itself in learning from actual ground truth/usage data. For instance, the system may receive one or more inputs that define conversions, purchases, feedback from users, feedback from consumers, etc. which represent ground truth information that includes relative parameters for determining a relative distance between geographical locations. Such information may be used to train a statistical model which determines how similar to particular geographic regions may be. At block 207, the system receives the ground truth/usage data and a block 208, performs an adjustment of the integration weights between the profile based distance metric and the co-occurrence based distance metrics. At block 209, process 200 ends.

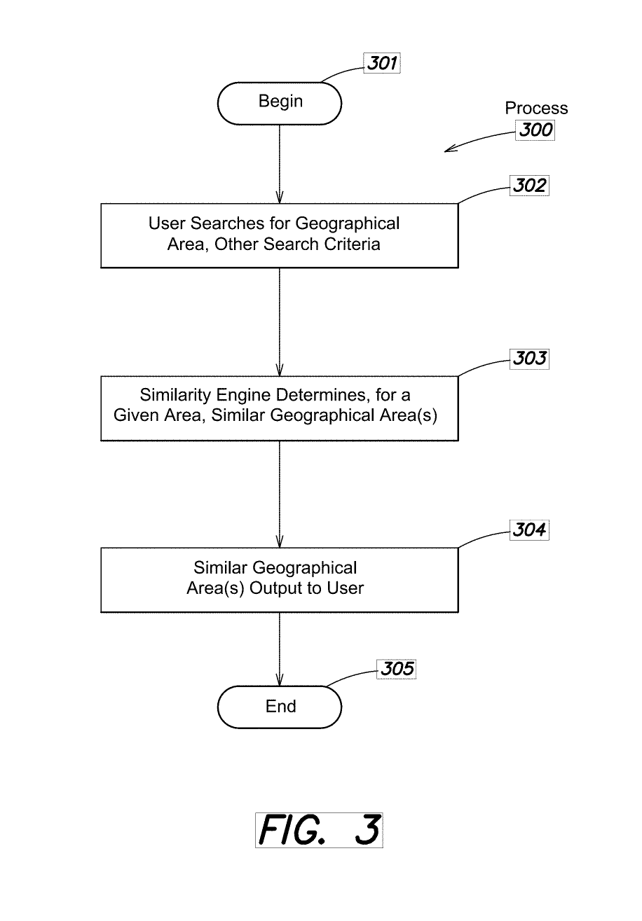

As discussed above, there may be one or more processes, systems, and/or users that may be capable of using similarity information determined by a similarity engine (e.g., similarity engine 108). FIG. 3 shows a diagram of an example process for using similarity information according to various embodiments. In particular, at block 301, process 300 begins. At block 302, in an example implementation, a user searches for a particular geographical area. For instance, the user may execute some query for a particular geographical area or may input the geographical area within a user interface (e.g., by selecting a particular geographical area within a display, identifying an address or region within a query input string, a menu drop-down function, or other computer interface type). The user may also provide some other type of search parameters (e.g., keywords) or other types of search criteria that may limit or otherwise qualify the similarity measure. At block 303, the similarity engine determines, for the identified geographical area, similar geographical areas. In various embodiments, the system may determine one or more areas and return those to a calling program or may present such information to the user within the interface (e.g., at block 304). At block 305, process 300 ends.

As discussed above, geographical areas such as neighborhoods can be evaluated for the purpose of comparison. External data that is indicative of particular features of a particular geographical area may be evaluated and used to train one or more statistical models that represent that neighborhood. For example, information that describes geographical features of an area, environmental conditions, computer vision technologies, point of interest (POI) information, individual and/or group behavioral data, venue information and its metadata, among others may be used to train a statistical model for the purpose of generating a profile of a particular geographical area (e.g., such as a neighborhood or a city).

### Example Implementation

As discussed above, it may be beneficial to train and model geographical areas such as neighborhoods in such a manner so that similarity information may be produced efficiently and quickly (e.g., in real time to support systems and applications) that consume such data. Further, it may be beneficial to allow the model to be adjusted in real time based on actual ground truth information such that the similarity information produced is more accurate.

In some embodiments, constructing a similarity metric between neighborhoods may include the following processes:

(1) Neighborhood Profile based distance computation
(2) Construction of Neighborhood co-occurrence based distance
(3) Integration of profile and co-occurrence based similarity measures
(4) Algorithmic adjustment of similarity measures via usage or ground truth data

In essence, components (1) and (2) produce different measures of similarity between all candidate neighborhoods, component (3) integrates these different similarity metrics into a single measure, and component (4) adjusts the weighting of different similarity measures feeding into component (3).

### Neighborhood Profile Construction and Similarity Computation

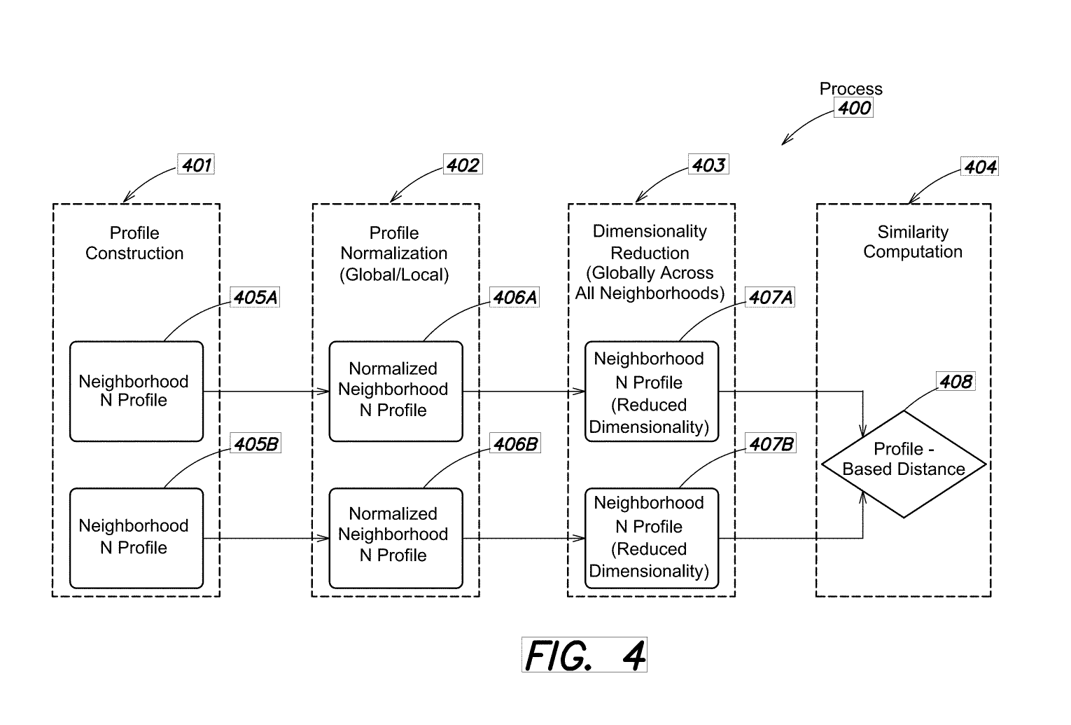

FIG. 4 shows an example process 400 for determining similarity information for a plurality of neighborhoods. Neighborhood profile-based similarity computation may, according to various embodiments, include several processes encompassing:

(1) Neighborhood profile construction (across all candidate neighborhoods) (e.g., at block 401)
(2) Neighborhood profile normalization (e.g., at block 402)
(3) Neighborhood profile dimensionality reduction (e.g., at block 403)
In one implementation, a neighborhood profile-based similarity computation (e.g., at block 404) results in a single number that assigns a similarity to every pair of neighborhoods. In such an implementation, the result of comparing a neighborhood with itself will always be 0.

### Neighborhood Profile Construction (Block 401)

For a given neighborhood N, the system can construct a neighborhood profile N_p (405A, 405B), which can be represented as a vector N_p={d1, d2, d3, . . . , dn}. Each dimension represents a different aspect of the neighborhood N which may be based on a variety of input data (POI data, photographs, maps, reviews, census data, etc.) and produced using a variety of technologies (statistical transformations, computer vision, map analysis, Natural Language Processing (NLP)).

For example, dimensions may include (but are in no way limited to):
The number of Vegetarian restaurants per square foot; This utilizes POI data (e.g., a list of establishments within a given area) and metadata (e.g., whether those establishments are vegetarian restaurants) and basic mathematics (e.g., division)
The visible presence of daylight; This utilizes street photography and computer vision technologies
The geometric complexity of streets; This utilizes street maps and computer vision technologies
The average level of restaurant hype; This utilizes POI data (e.g., list of establishments within a given area) and metadata (e.g., whether those establishments are restaurants), various text sources (e.g., user reviews, published reviews), Natural Language Processing and mathematics to integrate review scores across a variety of sources
   Because, according to various embodiments, one goal includes computing similarity across all neighborhoods N, it is important that all profiles have the same dimensions. So, for example, if there are no vegetarian restaurants within a given neighborhood, the system would arrive at a value (in this case, 0) for the number of Vegetarian restaurants per square foot.

### Neighborhood Profile Normalization (Block 402)

In neighborhood profile normalization, a set of neighborhood profiles {N_p} (e.g., profiles 406A, 406B) is determined corresponding to a set of neighborhoods {N} producing a set of normalized vectors with values ranging from 0-1. Different types of normalization may be determined by the system including local normalization and global normalization.

Local normalization normalizes every neighborhood profile N_p within the context of the metro region it is a part of. It is useful for answering questions such as “What is the Williamsburg (NY) of Los Angeles.” One way to produce a local normalization is, for each metro region, for each dimension, to divide by the largest value within the region. So for example, within New York City normalized values for The number of Vegetarian restaurants per square foot may be produced by finding the largest value within New York City for The number of Vegetarian restaurants per square foot and then dividing, across all neighborhoods, by this number. So the neighborhood that had the largest value for The number of Vegetarian restaurants per square foot would then have a normalized value of 1.0.

Global normalization normalizes every neighborhood profile N_p within the context of all neighborhoods in the dataset (rather than just those within the metro area each neighborhood is located in). This is useful for answering questions such as “Across all of the world, what neighborhood is most similar to Williamsburg (NYC).” It is noted that the answer to this question may well be within the same metro area that Williamsburg is in (NYC). The normalization procedure is very similar to Local normalization, however the largest value is taken from across the whole dataset, rather than just within the relevant metro area.

### Neighborhood Profile Dimensionality Reduction (Block 403)

Once a set of normalized neighborhood profiles {N_np} corresponding to each neighborhood N is determined, dimensionality reduction can be performed on these profiles to obtain another set of vectors {N_rdp} with a smaller set of reduced dimensions for each neighborhood N (e.g., reduced dimension profiles 407A, 407B). So, for example, if each element in {N_np} is a 64 dimensional vector, each element in {N_rdp} may end up being a 16 dimensional vector. Note that the |{N_np}|=|{N_rdp}|, as there is one vector for each neighborhood.

While there are many different approaches to dimensionality reduction, the system may use any method, including Primary Component Analysis (PCA). Applying PCA to a set of multidimensional vectors results in:

(1) A new set of transformed vectors in a new vector space (one vector for every vector in the original space)
(2) A Set Of Weights (SOW={w_rdi}) for how much variance each dimension of the new vector space explains of the original set of vectors. The sum of the set of weights is equal to 1 (explaining 100% of the variance of the original dataset).

The set of reduced dimensions may then be ranked by the amount of variance they explain [rd1, rd2, rd3, . . . , rdn]. Only the first m dimensions may be taken such that the sum of the variance explained by these dimensions is over 0.85 (explaining 85% of the variance of the original dataset) across all m dimensions but not across the first m−1 dimensions. With these m dimensions [rd1, rd2, . . . , rdm] in hand, a set of reduced vectors {N_rdp} can be constructed by only including these dimensions.

### Neighborhood Profile-Based Similarity Computation (Block 404)

With a set of reduced vectors {N_rdp}, the system can now compute a profile-based similarity metric that assigns a number to each pair of neighborhoods (N, N′) such that the most similar neighborhoods have scores approaching 0 (it will be 0 if N′=N), while the least similar neighborhoods have the largest value. This metric is referred to herein as D_pb. In some embodiments, D_pb may be defined as follows:

D_pb(N,N′)=Sum[across all dimensions rdi in rd1 . . . rdm]Square Root(N_rdi−N′_rdi)*(N_rdi−N′_rdi)*w_rdi

The last term in the equation ensures that the importance of each reduced dimension in determining neighborhood similarity is dependent upon how much variance that reduced dimension explains.

### Construction of Neighborhood Co-Occurrence Matrices

The system can construct other types of neighborhood similarity scores by evaluating lists of locations and counting the times that neighborhoods co-occur together on those lists. These lists may include in one example implementation (but are not limited to):
Touring schedules for all working musicians for a given year
Lists of locations that all US based architects have built buildings
Geographical user histories for a given set of users (e.g., a specific set of related users)
Locations of chain restaurants
   While actual touring schedules for musicians may need some transformations before it is in a usable form, it can be assumed that any of these set of lists {L} consists of lists of the following form L=[N_1, N_2, N_3, . . . , N_p]
   Then, for a given set of lists {L}, the system may construct a similarity measure D_I as follows:
1) For every pair of neighborhoods N, N′ (N!=N′) let m(N, N′, L)=0
2) Iterate through each list L_i. If two neighborhoods N and N′ appear together on the same list, increment m(N, N′, L) by 1
3) Let Max_co=Maximum (m(N, N′) across all N, N′ where N!=N′)
4) Set D_Lc (N, N′, L)=1−m(N, N′)/Max_co for all N, N′ with N!=N′
   This results in a set of values {m_normed (N, N′, L)} where D_Lc (N, N′, L)->0 if N, N′ co-occur on several lists and D_Lc (N, N′, L)=1 if N, N′ do not co-occur on any lists.

### Integration of Profile and Co-Occurrence Based Similarity Measures

In some embodiments, the system now combines multiple similarity metrics D_pb and D_Lc (for all sets of lists {L}) into a single aggregate similarity metric D as follows:
Let D(N,N)=0 for all neighborhoods N
If N!=N′, Let D(N,N′)=sum(w_i*D_Lic(N, N′, Li) across all sets of lists {Li})+w_p*D_pb(N, N′)
   In essence, for each of the different input similarity metrics, the system assigns a weight wj for {Li} or w_p that controls how much influence that input similarity metric has on the final metric. These weights can then be tuned manually by adjusting each weight and seeing how the adjustment impacts the relationship between neighborhood similarities, or they can be algorithmically modified.

### Algorithmic Adjustment of Similarity Measures Via Usage or Ground Truth Data

In some embodiments, the system can algorithmically adjust all of the weights involved in computing the aggregate similarity metric—both the weights that integrate the profile and co-occurrence measures, and the weights given to each of the reduced dimensions in computing the profile-based similarity measure. This adjustment can be made in accordance with a variety of different targets such as:
User usage data—If there is available data on the locations that a group of users has visited, the system can construct a target co-occurrence metric from this data, which the system can then tune the weights against
Any other set of lists (such as all artist concert listings, etc.)
   In essence, any other given similarity metric can be used as a ground truth, which the system can then train a model to predict like so.
   Let T(N, N′) be the target similarity between neighborhoods N and N′.
   Then the system can use the following equation:

sum(w_i*D_Lic(N,N′,Li) across all sets of lists {Li})+Sum[across all dimensions rdi in rd1 . . . rdm]Square Root(N_rdi−N′_rdi)*(N_rdi−N′_rdi)*w_rdi˜T(N,N′)

This training can be done using a variety of methodologies (Linear Regression, Logistic Regression, Random Forests, among other types of techniques).
In some embodiments, to algorithmically adjust the weights of the aggregate similarity metric to a target similarity metric, the following matrix may be constructed:
For every unique (irrespective of ordering) pairing of neighborhoods (N, N′) where N!=N′ for which have a value T(N, N′), construct a training matrix M_Tr as follows:
Let the row of M_Tr corresponding to (N, N′) consist of the following:

[D_Lic(N,N′,L_1), . . . ,D_Lic(N,N′,L_n), Square Root(N_rd1−N′_rd1)*(N_rd1−N′_rd1), . . . ,Square Root(N_rdm−N′_rdm)*(N_rdm−N′_rd1m]

Where n represents the total number of lists, and m represents the total number of dimensions in the neighborhood profile.
Then, construct a one dimensional matrix of target values, V_Ta corresponding to M_Tr by letting each value corresponding to row (N, N′) of M_Tr be equal to T(N, N′).
Putting it all together results in a matrix of training data and a vector of target values:

M_Tr=[D_Lic(N,N′,L_1), . . . ,D_Lic(N,N′,L_n),Square Root(N_rd1−N′_rd1)*(N_rd1−N′_rd1), . . . ,Square Root(N_rdm−N′_rdm)*(N_rdm−N′_rd1m]

V_ta=T(N,N′)

For all unique (irrespective of ordering) pairs (N,N′) where N!=N′ which have a value T(N, N′)
With this input, a model may be trained to predict the target similarity metric using a variety of methodologies. For example, a model (such as Linear Regression, Ridge Regression, Random Forests, or another suitable model) may take input formatted as the training matrix, target vector described above as the basis for training predictive models.

It should be appreciated that dimensionality reduction, neighborhood profile-based similarity computation, co-occurrence matrices, and algorithmic adjustment of similarity measures via usage or ground truth data are examples of artificial intelligence techniques used in some embodiments of the present disclosure. However, these embodiments are not so limited and other suitable artificial intelligence techniques may be applied where appropriate.

### Recommendation Using Similarities

Using the described set of similarities between neighborhoods, the system can make location recommendation for users and companies (e.g., via a recommendation engine). These recommendations can encompass any type of location based decision making, including (but not limited to) recommendations in response to questions such as:
What neighborhood or city should a person travel to on vacation?
What neighborhood or city should a person or family move to?
What are the optimal new (geo) markets that a company with a brick and mortar presence should target?

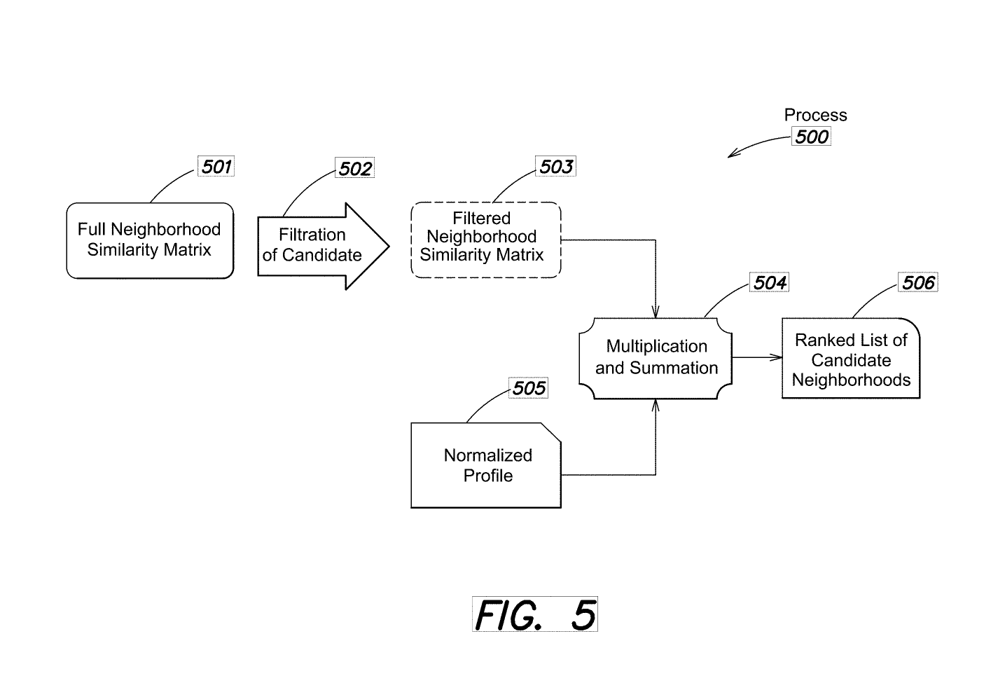

FIG. 5 shows an example process 500 for determining a ranking of candidate neighborhoods that could be used, for example, by a recommendation engine. At block 501, a full neighborhood similarity matrix may be constructed as discussed above with reference to FIG. 4. The recommendation process 500 has, according to some embodiments, several components:
1. A normalized user or company profile (represented as a vector, e.g. normalized profile 505) that can be passively measured or actively constructed via onboarding or inputting of sales data
2. Filtering of candidate neighborhoods and cities (at block 502) to produce a filtered neighborhood similarity matrix (e.g., block 503)
3. Multiplication of profile vector by filtered neighborhood similarity matrix; summation of distances (e.g., at block 504)
4. Ranked output list of candidate neighborhoods User/Company Neighborhood Profile vector (e.g., at block 506)
   The neighborhood profile vector, according to some embodiments, includes a set of neighborhoods with associated values that may represent affinity, user history, company data, and may be represented in the following form:

{
Neighborhood_1: Value_1,
Neighborhood_2: Value_2,
Neighborhood_3: Value_3,
Neighborhood_P: Value_P
}

Examples may include (but are not limited to):
User affinity for different neighborhoods as determined via an onboarding process. For example, a user may enter preferences for a set of neighborhoods via a graphical user interface. This can result in each candidate neighborhood receiving a value determined by how highly that user rates the neighborhood.
Passively determined user history. For example, a mapping or other location based service may keep a record of where a user has been. This record may consist of a set of lat-long coordinates, gps coordinates, etc., which can then be aggregated up to the neighborhood (most likely zipcode) level. The number of times that a user has been in each neighborhood then may provide the values for the neighborhood profile vector.
Various sources of data coming from companies. For example, for a company that has sales records from a variety of geographic locations (e.g., CPG companies, restaurant groups, grocery chains, etc.), sales data may be aggregated up to the neighborhood level, and then the sum of sales (or sum of sales per unit of time) provides the values for the neighborhood profile vector.
Once the vector has been constructed, the vector can then be normalized so that all values fall between 0 and 1. There are a variety of ways to do this, for example, dividing by the highest value in the vector.
This normalization results in a vector of the following form:

{
Neighborhood_1: Norm_N_1_val,
Neighborhood_2: Norm_N_2_val,
Neighborhood_3: Norm_N_3_val,
Neighborhood_P: Norm_N_P_val
}

### Filtering of Candidate Neighborhoods and Cities

In some embodiments, a next step in the recommendation process may include constructing the total set of candidate neighborhoods for recommendation. While it is possible to receive scores for all neighborhoods for which there are records, it is often desirable to narrow this set down to suit a user or company's needs. For example, if a person knows they have to travel to Portland, Oreg., they will only care about which neighborhoods in Portland to stay in, not neighborhoods they may like in San Diego, Calif. Likewise, if a company already has 20 stores in New York City and is looking to expand to Massachusetts, they may not want recommendations for NYC neighborhoods. This filtering can be done in a variety of ways, for example, through a graphical user interface.

### Multiplication of Profile Vector by Filtered Neighborhood Similarity Matrix; Summation of Distances

Once the set of candidate neighborhoods are determined, the system can, according to various embodiments, determine an aggregate preference score for each candidate neighborhood using the following formula:

N_c_score=Sum(Norm_N_i_val×D(N_c,N_i)) for all neighborhoods N_i in the Neighborhood Profile Vector.

Doing this, the system derives scores for all candidate neighborhoods N_c and can thus construct an ordered list according to these scores, where the lowest values of N_c_score represent the top recommendations for neighborhoods N_c.
For example,
The top five closest neighborhoods to Greenpoint, BK (zipcode: 11222) are:
The distance from Greenpoint/Williamsburg to Capitol Hill/Madison Park is 1.4802006204
The distance from Greenpoint/Williamsburg to Central Boulder is 1.50938535298
The distance from Greenpoint/Williamsburg to Central LA is 1.69676964633
The distance from Greenpoint/Williamsburg to Paradise Valley Village/South Scottsdale is 1.77686652426
The distance from Greenpoint/Williamsburg to Washington Ave./Memorial Park/Greater Heights is 1.91055530847
And here is an example of using this metric to find the closest neighborhoods to Greenpoint in other cities:

### the Greenpoint of la is Central LA 90027

### the Greenpoint of sf is Longfellow 94608

the Greenpoint of pdx is Mt. Tabor/Montavilla 97215
the Greenpoint of seattle is Capitol Hill/Madison Park 98112
the Greenpoint of boston is Ward Two/Prospect Hill 02143
the Greenpoint of chicago is Near South Side/Armour Square 60616
the Greenpoint of dallas is Deep Ellum/Old East Dallas 75226
the Greenpoint of denver is Central Boulder 80301
the Greenpoint of miami is Coconut Grove/Coral Way 33133

### the Greenpoint of phx is Paradise Valley Village/South Scottsdale 85253

Although the above list-based output information is shown by way of example, the system may be configured to provide such information in other manners, such as within a UI that shows divisions of geographical areas with certain distance metrics, colors signifying regions with similar metrics, or other graphical or programmatic indications.

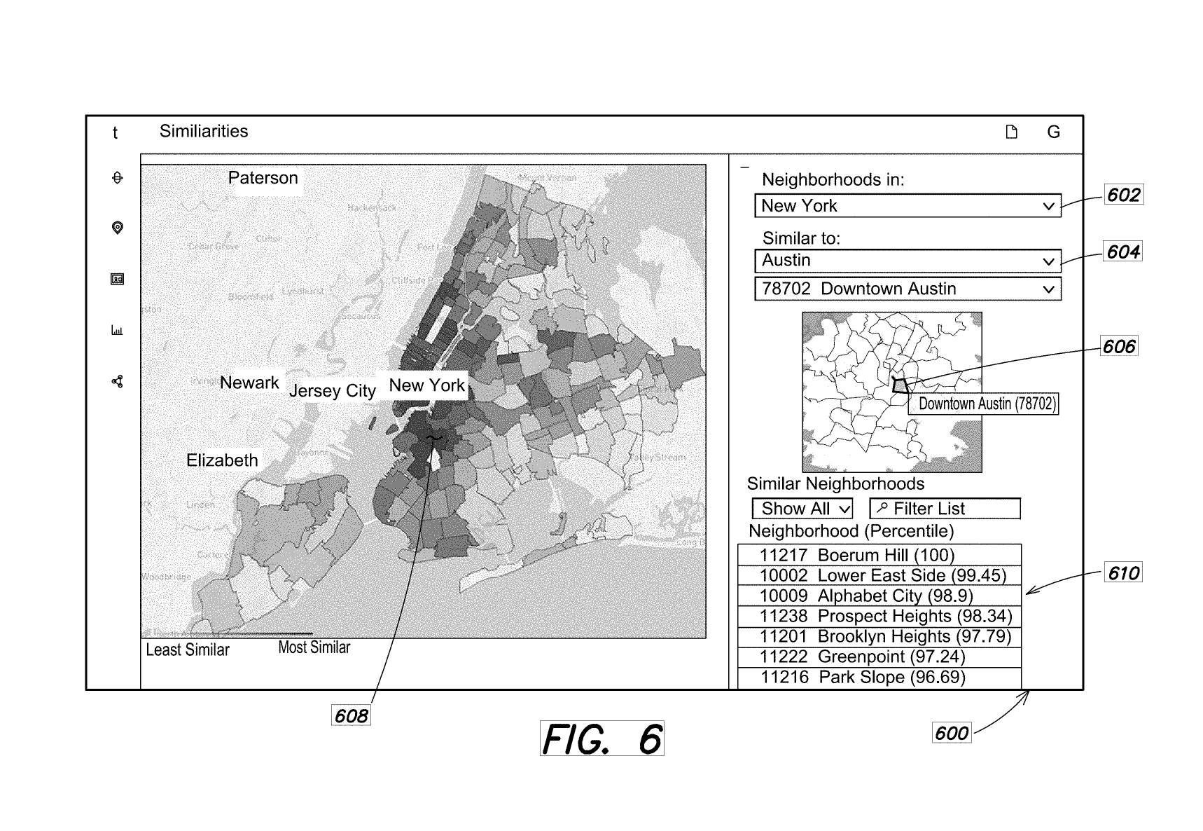

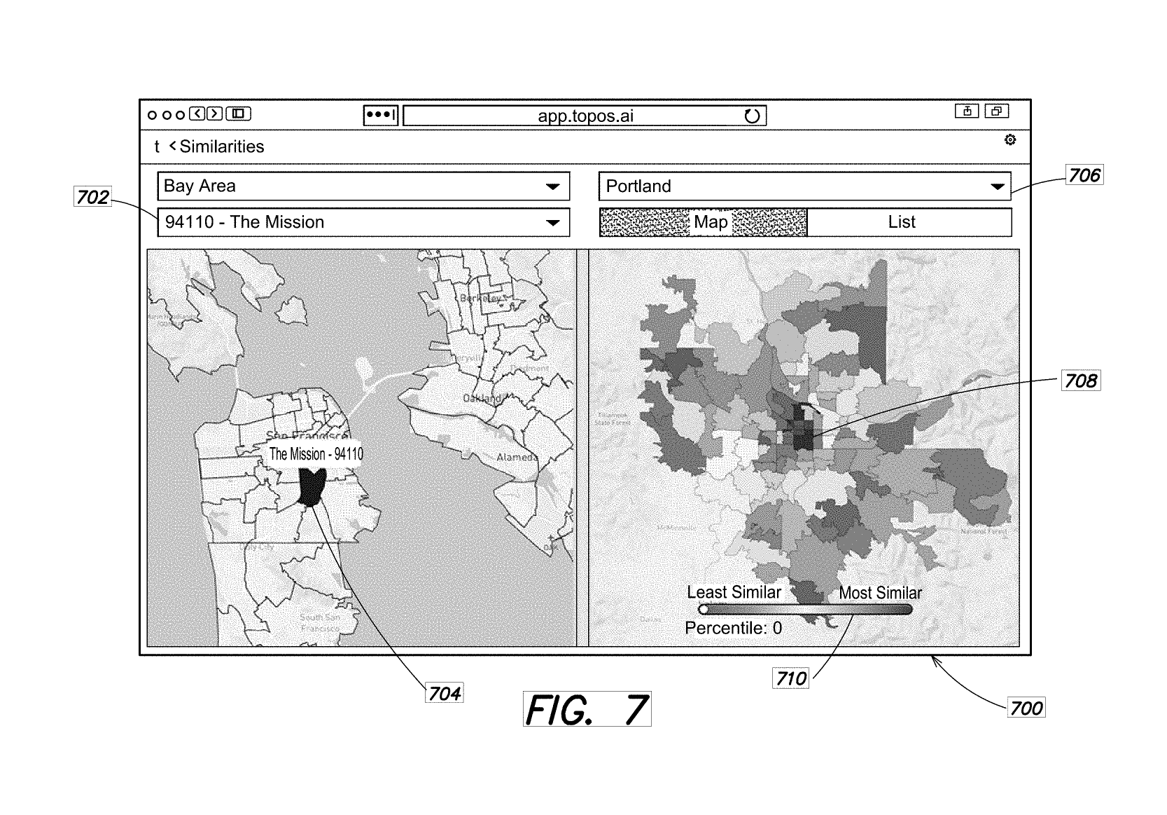

FIGS. 6-7 show exemplary user interfaces (UIs) for comparing geographical areas according to various embodiments. For example, FIG. 6 shows UI 600 where a user can search for neighborhoods in New York (box 602) that are similar to Austin (box 604). Optionally, the user may specify a zip code of Austin for the comparison. Map 606 shows a region of Downtown Austin corresponding to zip code 78702 specified by the user. Map 608 shows a color coded distribution of regions of New York that are similar to Downtown Austin. In this example, the darker shaded regions represent regions that are more similar to Downtown Austin than the lighter shaded regions. List 610 shows the zip codes and names of the neighborhoods that represent regions similar to Downtown Austin. Optionally, the list 610 may be sorted such that regions more similar to Downtown Austin are towards the top.

In another example, FIG. 7 shows UI 700 where a user can search for neighborhoods in Portland (box 706) that are similar to the Bay Area (box 702). Optionally, the user may specify a zip code in the Bay Area for the comparison. Map 704 shows a region of The Mission corresponding to zip code 94110 specified by the user. Map 708 shows a color coded distribution of regions of Portland that are similar to The Mission. In this example, the darker shaded regions represent regions that are more similar to The Mission than the lighter shaded regions. Legend 710 shows a color distribution of the neighborhoods that represent regions that are more or less similar to The Mission.

Further, it should be appreciated that in some embodiments, predefined geographical areas may be used as an input to the system, the system itself may use similarity information to determine new geographies. For instance, existing geographies may be subdivided, and new geographical areas may be determined having different boundaries determined using subareas representing a higher resolution of data points.

### Similarities Across Time & Neighborhood Forecasting

In some embodiments, the described systems and methods provide for similarity metrics that may be used to predict the evolution of neighborhoods. For example, the similarity metrics may be used to answer the question, “What will the Williamsburg of San Francisco be in 5 years?” or “What neighborhood in New York is currently most like Williamsburg was in 2010?”

The general approach to answering these questions may include appropriately selecting the input features for neighborhood profile creation (e.g., looking not just at current snapshots of features, but also historical features, the change in features over time, and projections of future features), applying dimensionality reduction, and then applying the neighborhood profile-based similarity computation (e.g., as described with respect to block 404) or a variation thereof. Some or all of these computations may rely upon the availability of time-stamped historical features.

The following examples illustrate some embodiments where the described systems and methods provide for similarity metrics that may be used to predict the evolution of neighborhoods. The following description is by way of example only, and is not intended to be limiting.

### Example 1: “What Will the Williamsburg of San Francisco be in 5 Years?”

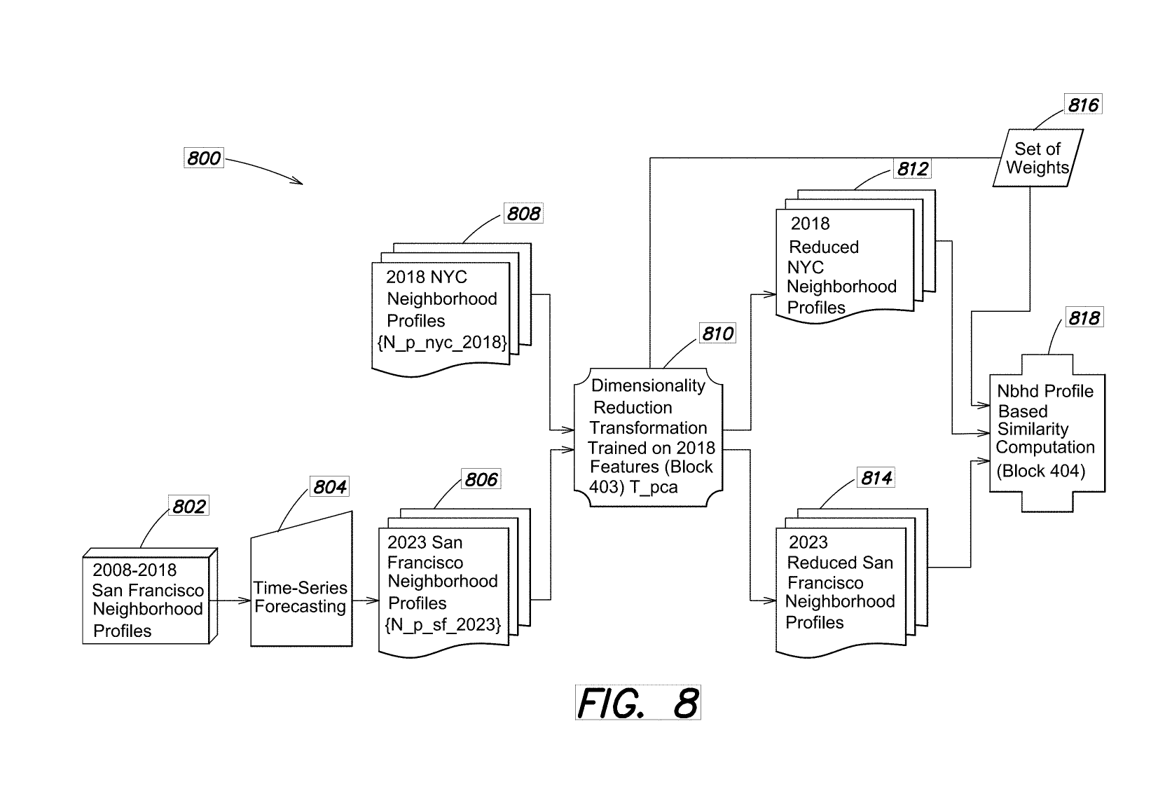

To answer this question, the following feature sets may be used. FIG. 8 provides block diagram 800 to illustrate the process of this example.
Current neighborhood profiles for all New York City (NYC) neighborhoods (block 808)
5 year projected neighborhood profiles (across the same features) for all San Francisco (SF) neighborhoods (block 806)

The first feature set is one such as is described in the neighborhood profile construction (e.g., as described with respect to block 401), taken across all neighborhoods in NYC. For example, neighborhood profiles for all NYC neighborhoods in 2018 may be denoted as {N_p_nyc_2018} (block 808).

To construct the second feature set, it may be required to make future projections for all features in the first feature set across all neighborhoods in SF. There are a variety methodologies that may be used to make forecasts of metrics, such as Extrapolation, Linear Prediction, Kalman Filtering, any of which may be used, and some or all of which may rely upon the availability of time stamped historical features. For example, for features available for San Francisco for years 2008-2018 (block 802), and for those features that are the same as those available in New York, the time series for each feature may be used to predict future values for features in 2023 using Linear Extrapolation (block 804). This set may be denoted as {N_p_sf_2023} (block 806).

Block diagram 800 shows the two sets of neighborhood profiles across the same set of features as follows:
2018 NYC Neighborhood Profiles={N_p_nyc_2018} (block 808)
2023 San Francisco (predicted) Neighborhood Profiles={N_p_sf_2023} (block 806)

In order to apply the neighborhood profile based similarity computation (e.g., as described with respect to block 404), it may be required to reduce the dimensionality of these feature sets to factor in correlated features (block 810). Many different dimensionality reduction algorithms may be used including, e.g., Primary Component Analysis (PCA), to properly reduce the dimensions. In order to use PCA on both 2018 features (block 808) and predicted 2023 features (block 806), a PCA transformation may be trained on 2018 data from both SF and NYC. This may produce:
Transformation (T_pca) which takes input vectors from 2018 or any other year (as long as the features are the same) and produces a vector in the reduced space (block 810)
a set of weights (SOW) for appropriately weighting the dimensions in the reduced space (block 816)

T_pca may be applied to {N_p_nyc_2018} (block 808) and {N_p_sf_2023} (block 806), resulting in two sets of dimensionally reduced feature sets:
2018 NYC Reduced Neighborhood Profiles={N_r_p_nyc_2018} (block 812)
2023 San Francisco (predicted) Reduced Neighborhood Profiles={N_r_p_sf_2023} (block 814)

Using these reduced profiles and the SOW, the neighborhood profile-based similarity computation (e.g., as described with respect to block 404) may be applied to produce a score for every pairing (N, N′) of neighborhoods in 2018 NYC and 2023 San Francisco (block 818). To answer the question “What will the Williamsburg of San Francisco be in 5 years?”, the shortest distance between Williamsburg and each of the 2023 San Francisco neighborhoods may be determined. This may be mathematically represented as: Minimum (D_pb (Williamsburg, N′) across all neighborhoods N′ in San Francisco).

### Example 2: “What Neighborhood in New York is Currently, in 2018, Most Like Williamsburg was in 2010?”

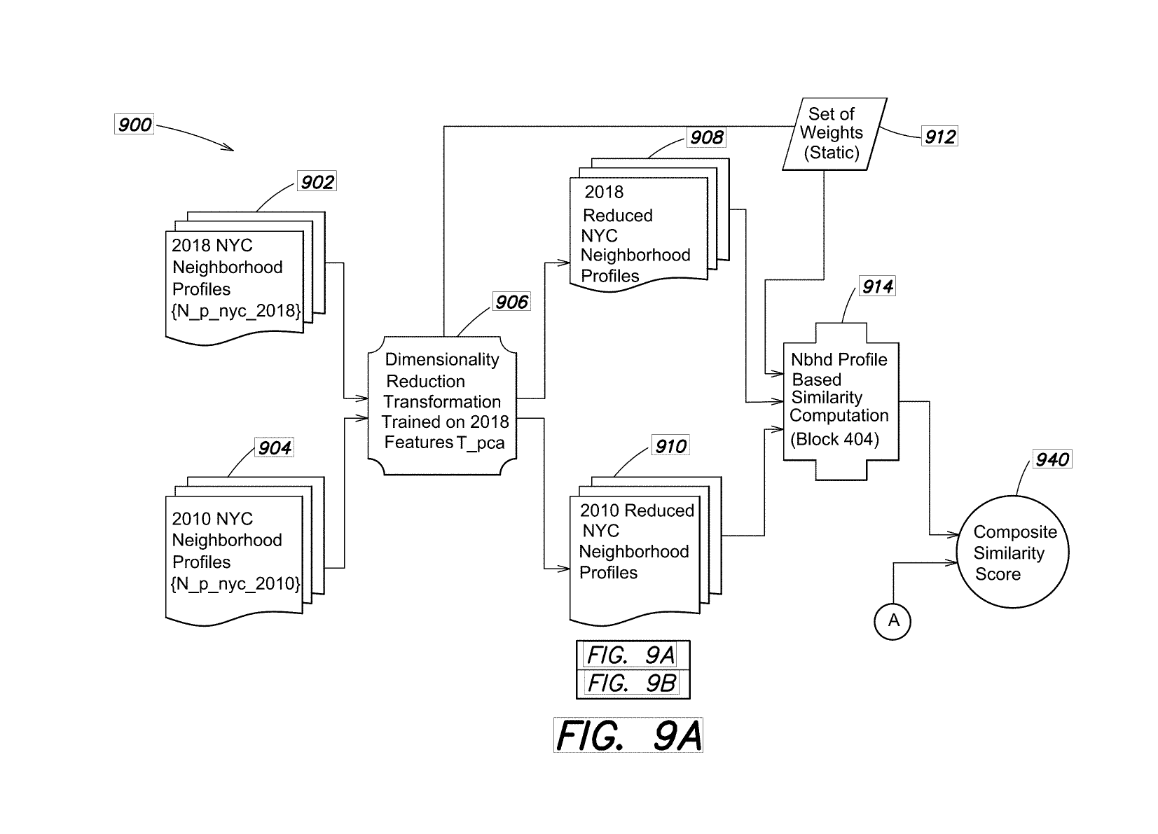

One way of answering this question, which accounts for not only the existential similarities between 2010 Williamsburg and 2018 New York City neighborhoods but also for the rapidity of change that Williamsburg experienced during the past 20 years, is to look at both static neighborhood profiles and changes in neighborhood profiles over time. FIGS. 9A-9B provides block diagram 900 to illustrate the process of this example.

In some embodiments, one way to construct a score which reflects both of these aspects is to produce two neighborhood similarity scores, an Existential Similarity Score based on static profiles from 2010 and 2018 and a Dynamic Similarity Score based on the way neighborhoods evolved over the 2 years preceding 2010 and 2018 respectively, and take the mean of these two scores.

In some embodiments, the Existential Similarity Score (2010 to 2018) may be a modification of the neighborhood profile-based similarity computation (e.g., as described with respect to block 404). The key difference is observing similarity across neighborhood profiles from two different time periods (2010 and 2018) and training the dimensionality reduction transformation on features from 2018. In order to do so, the following feature sets may be examined:
2018 neighborhood profiles for all NYC neighborhoods {N_p_nyc_2018} (block 902)
2010 neighborhood profiles for all NYC neighborhoods {N_p_nyc_2010} (block 904)

Both feature sets are such as is described in the neighborhood profile construction (e.g., as described with respect to block 401), taken across all neighborhoods in NYC, with the key modification that they have specific time stamps (2018 and 2010). In order to apply the neighborhood profile based similarity computation (e.g., as described with respect to block 404) or a variation thereof, it may be required to reduce the dimensionality of these feature sets to factor in correlated features (block 906). Many different dimensionality reduction algorithms may be used including, e.g., Primary Component Analysis (PCA), to properly reduce the dimensions. In order to use PCA on both 2018 features (block 902) and 2010 features (block 904), a PCA transformation may be trained on 2018 data from NYC. This may produce:
Transformation (T_pca) which takes input vectors from 2018 or any other year (as long as the features are the same) and produces a vector in the reduced space (block 906)
a set of weights (SOW static) for appropriately weighting the dimensions in the reduced space (block 912)

T_pca may be applied to {N_p_nyc_2018} (block 902) and {N_p_nyc_2010} (block 904), resulting in two sets of dimensionally reduced feature sets:
2018 NYC Reduced Neighborhood Profiles={N_r_p_nyc_2018} (block 908)
2010 NYC Reduced Neighborhood Profiles={N_r_p_nyc_2010} (block 910)

Using these reduced profiles and the SOW, the neighborhood profile-based similarity computation (e.g., as described with respect to block 404) may be applied to produce a score for every pairing (N, N′) of neighborhoods in 2018 NYC and 2010 NYC (block 914). To produce an Existential answer to the question “What neighborhood in New York is currently, in 2018, most like Williamsburg was in 2010?”, the shortest distance between Williamsburg in 2010 and each of the 2018 NYC neighborhoods may be found. This may be mathematically represented as: Minimum (D_pb (Williamsburg in 2010, N′) across all neighborhoods N′ in NYC in 2018).

In some embodiments, the Dynamic Similarity Score (2010 to 2018) may be a modification of the neighborhood profile-based similarity computation (e.g., as described with respect to block 404). The key difference is observing how neighborhoods have changed in two different time periods (2016-2018 and 2008-2010). In order to do so, the following feature sets may be examined:
2016-2018 changes in neighborhood profiles for all NYC neighborhoods {N_d_p_nyc_2018} (block 922)
2008-2010 changes in neighborhood profiles for all NYC neighborhoods {N_d_p_nyc_2010} (block 924)

The construction of each of these “change profiles” may rely upon the availability of time stamped neighborhood profiles such as the ones described in the neighborhood profile construction (e.g., as described with respect to block 401). With two time stamped sets of neighborhood profiles, for example {N_p_nyc_2016} and {N_p_nyc_2018}, the differential may be calculated to produce a neighborhood change profile. This may be mathematically represented as: N_d_p_nyc_2018 (d)=N_d_p_nyc_2018 (d)−N_d_p_nyc_2016 (d), for all dimensions d in the neighborhood profile. It is noted that this assumes dimensions are consistently available across different time stamps.

In order to apply the neighborhood profile based similarity computation (e.g., as described with respect to block 404) or a variation thereof, it may be required to reduce the dimensionality of these change feature sets to factor in correlated features (block 926). Many different dimensionality reduction algorithms may be used including, e.g., Primary Component Analysis (PCA), to properly reduce the dimensions. In order to use PCA on both 2016-2018 change features (block 922) and 2008-2010 change features (block 924), a PCA transformation may be trained on 2016-2018 change features from NYC. This may produce:
Transformation (T_pca) which takes input change vectors and produces a vector in the reduced space (block 926)
a set of weights (SOW change) for appropriately weighting the dimensions in the reduced space (block 932)

T_pca may be applied to {N_d_p_nyc_2018} (block 922) and {N_d_p_nyc_2010} (block 924), resulting in two sets of dimensionally reduced feature sets:
2018 NYC Reduced Neighborhood Change Profiles={N_r_d_p_nyc_2018} (block 928)
2010 NYC Reduced Neighborhood Change Profiles={N_r_d_p_nyc_2010} (block 930)

Using these reduced profiles and the SOW, the neighborhood profile-based similarity computation (e.g., as described with respect to block 404) may be applied to produce a score for every pairing (N, N′) of neighborhoods in 2018 NYC and 2010 NYC (block 934). To produce a Dynamic answer to the question “What neighborhood in New York is currently, in 2018, most like Williamsburg was in 2010?,” the shortest distance between the way Williamsburg changed between 2008 and 2010 and the change all NYC neighborhoods experienced between 2016 and 2018 may be found. This may be mathematically represented as: Minimum (D_pb (Williamsburg 2008-2010 change, N′) across all 2016-2018 changes in neighborhoods N′ in NYC).

Finally, both dynamic and existential similarity scores may be combined to determine a composite score (block 940). In some embodiments, the Existential Similarity Score, based on static profiles from 2010 and 2018 and the Dynamic Similarity Score, based on the way neighborhoods evolved over the 2 years preceding 2010 and 2018 respectively, may be combined by taking the mean of these two scores. The composite score may be used the answer the question “What neighborhood in New York is currently, in 2018, most like Williamsburg was in 2010?”

### Example Computer Architecture

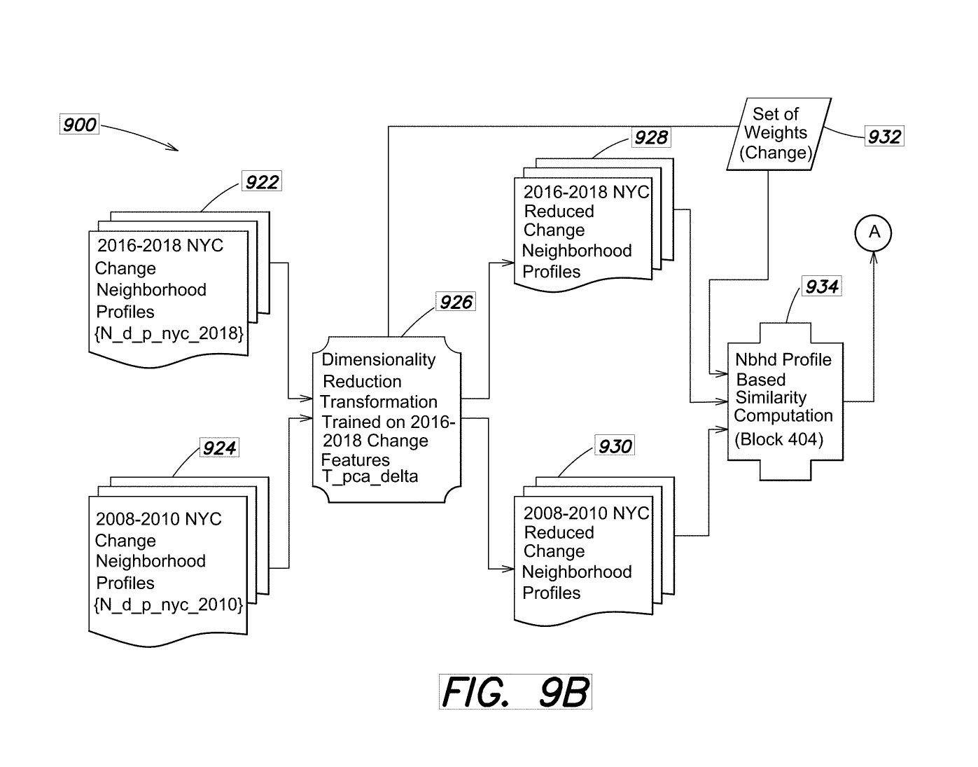

One example implementation of an artificial intelligence system is shown in FIG. 10. In particular, system 1000 may include one or more processors 1001 that are operable to create, train, execute, and update one or more statistical models and/or templates (e.g., element 1003). Such information may be stored within memory or persisted to storage media. In some embodiments, processors 1001 may receive one or more sources of location-based data 1002 that is indicative of one or more graphical regions. Processors 1001 may be configured to train the statistical model or other artificial intelligence model (e.g., a neural network) to permit the system to determine similarity between one or more geographical regions. Processors 1001 may be capable of producing similarity scores 1004 based on the given reference region. The similarity scores, according to various embodiments, may be normalized in that lower values indicate that a geographical region is close to the reference region, and a value of one may indicate that the geographical region is dissimilar from the reference region. It should be appreciated that such a scoring system may have many implementations.

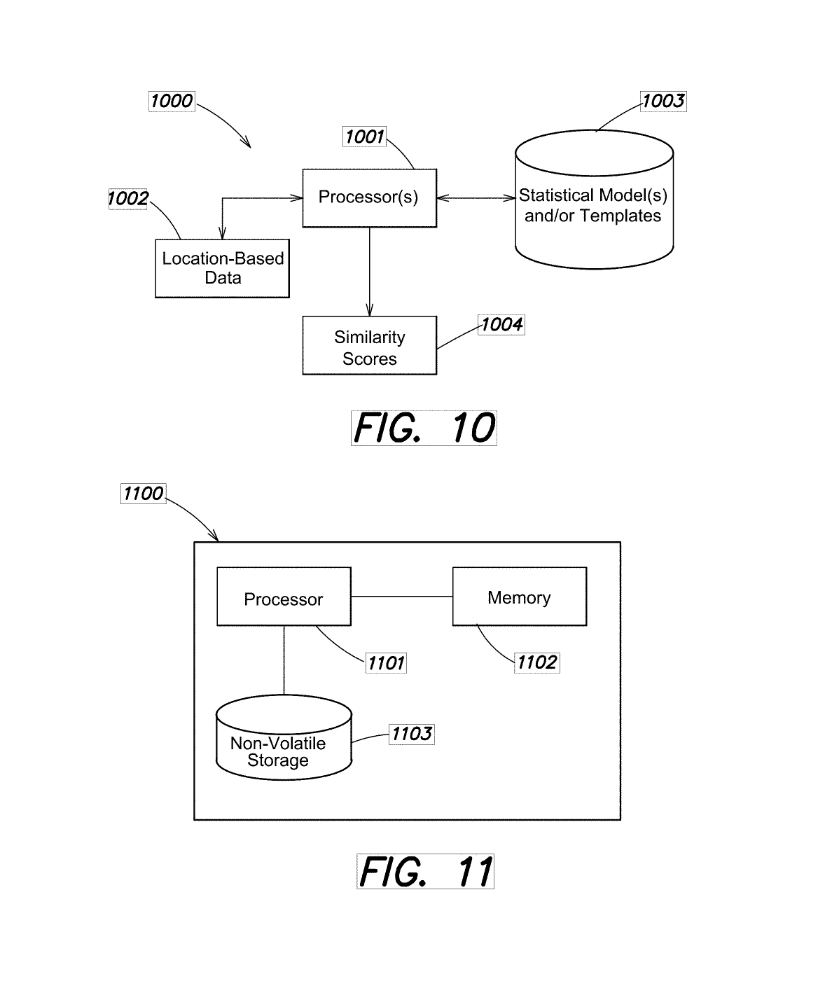

An illustrative implementation of a computing device 1100 that may be used in connection with any of the embodiments of the disclosure provided herein is shown in FIG. 11. The computing device 1100 may include one or more processors 1101 and one or more articles of manufacture that comprise non-transitory computer-readable storage media (e.g., memory 1102 and one or more non-volatile storage media 1103). The processor 1101 may control writing data to and reading data from the memory 1102 and the non-volatile storage device 1103 in any suitable manner. To perform any of the functionality described herein, the processor 1101 may execute one or more processor-executable instructions stored in one or more non-transitory computer-readable storage media (e.g., the memory 1103), which may serve as non-transitory computer-readable storage media storing processor-executable instructions for execution by the processor 1101.

The terms “program” or “software” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

All definitions, as defined and used herein, should be understood to control over dictionary definitions, and/or ordinary meanings of the defined terms.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. A system comprising:
a processor;
a storage device coupled to the processor;
a memory device coupled to the processor and memory;
an interface adapted to receive a plurality of parameter values relating to a plurality of geographical areas;
a plurality of components, executable by one or more processors, the components comprising:
a component adapted to determine, for each of the plurality of geographical areas, a respective profile, the profile including a plurality of data points relating to activity performed within a respective area;
a component adapted to determine a respective normalized profile based on each respective profile associated with the plurality of geographical areas; and
a component adapted to determine a similarity measure of at least one of the plurality of geographical areas to a reference geographical area.

2. The system according to claim 1, further comprising a component adapted to reduce a dimensionality of each of the normalized profiles.

3. The system according to claim 1, wherein the plurality of geographical areas include at least one of a group comprising a neighborhood, a city, a state, a user-defined area, and a virtual area.

4. The system according to claim 1, further comprising a component that provides an output, the output including the determined similarity measure.

5. The system according to claim 1, further comprising a component adapted to determine a co-occurrence based distance metric for each of the plurality of geographical areas.

6. The system according to claim 5, further comprising a component adapted to determine a profile-based distance metric for each of the plurality of geographical areas.

7. The system according to claim 6, further comprising a component adapted to combine the co-occurrence based distance metric and the profile-based distance metric for each of the plurality of geographical areas into a single distance metric.

8. The system according to claim 7, further comprising a weighting component that adjusts a weighting between the co-occurrence based distance metric and the profile-based distance metric for each of the plurality of geographical areas.

9. The system according to claim 1, wherein the plurality of data points relating to activity performed within a respective area includes at least one of a group of data sources including POI data, photographs, map data, and census data.

10. The system according to claim 9, wherein the plurality of data points are derived by one or more processes including statistical transformations, computer vision, map analysis, and natural language processing.

11. A method comprising:
receiving a plurality of parameter values relating to a plurality of geographical areas;
determining, for each of the plurality of geographical areas, a respective profile, the profile including a plurality of data points relating to activity performed within a respective area;
determining a respective normalized profile based on each respective profile associated with the plurality of geographical areas; and
determining a similarity measure of at least one of the plurality of geographical areas to a reference geographical area.

12. The method according to claim 11, further comprising reducing a dimensionality of each of the normalized profiles.

13. The method according to claim 11, wherein the plurality of geographical areas include at least one of a group comprising a neighborhood, a city, a state, a user-defined area, and a virtual area.

14. The method according to claim 11, further comprising providing an output, the output including the determined similarity measure.

15. The method according to claim 11, further comprising determining a co-occurrence based distance metric for each of the plurality of geographical areas.

16. The method according to claim 15, further comprising determining a profile-based distance metric for each of the plurality of geographical areas.

17. The method according to claim 16, further comprising combining the co-occurrence based distance metric and the profile-based distance metric for each of the plurality of geographical areas into a single distance metric.

18. The method according to claim 17, further comprising adjusting a weighting between the co-occurrence based distance metric and the profile-based distance metric for each of the plurality of geographical areas.

19. The method according to claim 11, wherein the plurality of data points relating to activity performed within a respective area includes at least one of a group of data sources including POI data, photographs, map data, and census data.

20. The method according to claim 19, wherein the plurality of data points are derived by one or more processes including statistical transformations, computer vision, map analysis, and natural language processing.

21. A system, comprising:
at least one computer hardware processor;
at least one non-transitory computer-readable storage medium storing processor-executable instructions that, when executed by the at least one computer hardware processor, cause the at least one computer hardware processor to perform:
receiving, for each of a plurality of geographical areas, a respective plurality of parameter values;
determining, for each of the plurality of geographical areas, a respective profile, the profile including a subset of the plurality of parameter values relating to activity performed within a respective geographical area;
determining, for each of the plurality of geographical areas, a respective normalized profile based on the respective profile associated with the respective geographical area; and
determining, for first and second geographical areas of the plurality of geographical areas, based on the respective normalized profiles for the first and second geographical areas, a similarity measure for comparing the first and second geographical areas.

22. A method, comprising:
receiving, for each of a plurality of geographical areas, a respective plurality of parameter values;
determining, for each of the plurality of geographical areas, a respective profile, the profile including a subset of the plurality of parameter values relating to activity performed within a respective geographical area;
determining, for each of the plurality of geographical areas, a respective normalized profile based on the respective profile associated with the respective geographical area; and
determining, for first and second geographical areas of the plurality of geographical areas, based on the respective normalized profiles for the first and second geographical areas, a similarity measure for comparing the first and second geographical areas.
